(19) United States
(12) Patent Application Publication
(10) Pub. No.: US 2014/0071199 A1
(43) Pub. Date: Mar. 13, 2014

(54) COMPOSITE COMPONENT MOLDING METAL MOLD, DROPLET DISCHARGE HEAD, ELECTRONIC DEVICE, AND IMAGE FORMING APPARATUS

(71) Applicants: Yukitoshi Tajima, Kanagawa (JP); Takafumi Sasaki, Kanagawa (JP)

(72) Inventors: Yukitoshi Tajima, Kanagawa (JP); Takafumi Sasaki, Kanagawa (JP)

(73) Assignee: RICOH Company, Ltd., Tokyo (JP)

(21) Appl. No.: 14/018,586

(22) Filed: Sep. 5, 2013

(30) Foreign Application Priority Data
Sep. 10, 2012 (JP) 2012-198947

(51) Int. Cl. B41J 2/135; B29C 33/00

(52) U.S. Cl. CPC B41J 2/135; B29C 33/00
USPC 347/29; 425/357; 264/250; 347/70

(57) ABSTRACT

Disclosed is a composite component molding metal mold including a first metal mold for molding a first molded product, and a second metal mold for molding a second molded product. Each of the first and second metal molds includes a movable mold and a stationary mold. Each of the stationary molds includes a male mold and a female mold, and each of the movable molds includes a male mold and a female mold. A cavity for molding the first molded product is formed by a combination of the female mold of the stationary mold and the male mold of the movable mold, and another cavity for molding the second molded product is formed by another combination. A space which is in communication with the cavity and the other cavity is provided. When an insertion member is inserted into the space, the cavity and the other cavity are isolated.

### BACKGROUND OF THE INVENTION

1. Field of the Invention

The present invention relates to a composite component molding metal mold, a droplet discharge head, an electronic device, and an image forming apparatus. Specifically, the present invention relates to a composite component molding metal mold that forms a component such as a liquid discharge head (e.g., an inkjet recording head) or an electronic device component. The composite component molding metal mold integrates two molded products having different functions by a two-material injection molding method. Here, the two molded products are formed of two corresponding types of resins (two materials). The present invention also relates to a printer, a facsimile machine, a copier, a plotter, or a combined machine thereof.

2. Description of the Related Art

A technique has been known in which a desired molded product is produced by injection molding (e.g., Patent Document 1 (Japanese Unexamined Patent Publication No. 2007-331320), Patent Document 2 (Japanese Unexamined Patent Publication No. H10-315276), and Patent Document 3 (Japanese Unexamined Patent Publication No. 2003-034044)). Recently, a two-material molding process has been applied for producing various products. In the two-material molding process, a two-material integrally molded product is molded in a metal mold by sequentially injecting two types (two materials or two colors) of resins such as thermoplastic resins. The two-material integrally molded product is molded by a composite component molding metal mold including a movable side metal mold and a stationary side metal mold. The stationary side metal mold includes a first metal mold and a second metal mold. In the first metal mold, a cavity is formed which is for molding a first material molded product. In the second mold, a cavity is formed which is for molding a second material molded product. The first mold and the second mold are symmetrically disposed across a rotational axis, while the first mold and the second mold are integrated. The movable side metal mold is disposed to face the stationary side metal mold. In the movable side metal mold, a male mold and a female mold are formed for the cavity of the first metal mold, and another male mold and another female mold are formed for the cavity of the second metal mold.

In the two-material molding process by the composite component molding metal mold, the movable side metal mold is pressed toward the stationary side metal mold, and the first material molded product is molded by the cavity which is formed in the first metal mold. Subsequently, the movable side metal mold is separated from the stationary side metal mold, and the movable side metal mold is rotated by 180 degrees around the rotational axis, while leaving the first material molded product inside the movable side metal mold. Next, the movable side metal mold is pressed toward the stationary side metal mold again, and the second material molded product is molded by the cavity which is formed in the second metal mold. Then, the movable side metal mold is separated from the stationary side metal mold, and the integrated two-material molded product is taken out from the movable side metal mold. In the actual molding, the injection in the first metal mold and the injection in the second metal mold are almost simultaneously performed from a second round. One integrated complex molded product is obtained per a half turn of the movable side metal mold.

As described above, after molding the first material molded product by the first metal mold, the first material molded product is moved to the second metal mold, while leaving the first material molded product inside the movable side metal mold. The second material molded product is molded by the second metal mold. Accordingly, when the second material molded product is molded by the second metal mold, it may be necessary to protect the first molded product from heat, damage, or burring, for example.

Patent Document 1 discloses a technique which is related to a shape of a two-color molding metal mold, which prevents a first color material) molded member from being damaged by the two-color molding metal mold. Specifically, a tip of a portion of the metal mold, which defines a boundary portion between the first material molded product and the second material molded product, is formed to have a shape which includes at least an obtuse angle, and thereby the first color molded member is protected from being damaged.

Patent Document 2 discloses a metal mold structure and a shape of an insertion member for inserting a metal inside a molded body, so that dimensional accuracy of the molded body of an inkjet head is maintained. Patent Document 3 discloses eliminating a bonding process by molding a component of an inkjet printer by multicolor injection molding, in which a plastic component with an elastic body (an elastomer) is integrally formed.

### SUMMARY OF THE INVENTION

According to one aspect of the present invention, there is provided a composite component molding metal mold configured to mold a composite component, the composite component molding metal mold including

a first metal mold configured to mold a first molded product with a first resin material; and

a second metal mold configured to mold a second molded product with a second resin material,

wherein the first metal mold includes a first movable side metal mold and a first stationary side metal mold, and the second metal mold includes a second movable side metal mold and a second stationary side metal mold,

wherein the first metal mold includes a first male mold and a first female mold which are disposed on the first stationary side metal mold, and the first metal mold includes a second male mold and a second female mold which are disposed on the first movable side metal mold,

wherein the second metal mold includes a third male mold and a third female mold which are disposed on the second stationary side metal mold, and the second metal mold includes a fourth male mold and a fourth female mold which are disposed on the second movable side metal mold,

wherein, in the first metal mold, a first cavity for molding the first molded product is formed by a first combination of the first female mold and the second male mold, and a second cavity for molding the second molded product is formed by a second combination of the first male mold and the second female mold,

wherein, in the second metal mold, a third cavity for molding the first molded product is formed by a third combination of the third female mold and the fourth male mold, and a fourth cavity for molding the second molded product is formed by a fourth combination of the third male mold and the fourth female mold,

wherein a first space which is in communication with the first cavity and the second cavity is provided between the first cavity and the second cavity, and a second space which is in communication with the third cavity and the fourth cavity is provided between the third cavity and the fourth cavity,

wherein, when a first insertion member is inserted into the first space, the first cavity and the second cavity are isolated, and

wherein, when a second insertion member is inserted into the second space, the third cavity and the fourth cavity are isolated.

According to another aspect of the present invention, there is provided a droplet discharge head including

a composite component,

wherein, in the composite component, a common liquid chamber, a liquid channel, and a chassis are integrally formed on a first insertion member,

wherein the composite component is molded by a composite component molding metal mold,

wherein the composite component molding metal mold includes

a first metal mold configured to mold a first molded product with a first resin material; and

a second metal mold configured to mold a second molded product with a second resin material,

wherein the first metal mold includes a first movable side metal mold and a first stationary side metal mold, and the second metal mold includes a second movable side metal mold and a second stationary side metal mold,

wherein the first metal mold includes a first male mold and a first female mold which are disposed on the first stationary side metal mold, and the first metal mold includes a second male mold and a second female mold which are disposed on the first movable side metal mold,

wherein the second metal mold includes a third male mold and a third female mold which are disposed on the second stationary side metal mold, and the second metal mold includes a fourth male mold and a fourth female mold which are disposed on the second movable side metal mold,

wherein, in the first metal mold, a first cavity for molding the first molded product is formed by a first combination of the first female mold and the second male mold, and a second cavity for molding the second molded product is formed by a second combination of the first male mold and the second female mold,

wherein, in the second metal mold, a third cavity for molding the first molded product is formed by a third combination of the third female mold and the fourth male mold, and a fourth cavity for molding the second molded product is formed by a fourth combination of the third male mold and the fourth female mold,

wherein a first space which is in communication with the first cavity and the second cavity is provided between the first cavity and the second cavity, and a second space which is in communication with the third cavity and the fourth cavity is provided between the third cavity and the fourth cavity,

wherein, when the first insertion member is inserted into the first space, the first cavity and the second cavity are isolated, and

wherein, when a second insertion member is inserted into the second space, the third cavity and the fourth cavity are isolated.

According to another aspect of the present invention, there is provided an image forming apparatus including

a droplet discharge head,

wherein the droplet discharge head includes a composite component,

wherein, in the composite component, a common liquid chamber, a liquid channel, and a chassis are integrally formed on a first insertion member,

wherein the composite component is molded by a composite component molding metal mold,

wherein the composite component molding metal mold includes

a first metal mold configured to mold a first molded product with a first resin material; and

a second metal mold configured to mold a second molded product with a second resin material,

wherein the first metal mold includes a first movable side metal mold and a first stationary side metal mold, and the second metal mold includes a second movable side metal mold and a second stationary side metal mold,

wherein the first metal mold includes a first male mold and a first female mold which are disposed on the first stationary side metal mold, and the first metal mold includes a second male mold and a second female mold which are disposed on the first movable side metal mold,

wherein the second metal mold includes a third male mold and a third female mold which are disposed on the second stationary side metal mold, and the second metal mold includes a fourth male mold and a fourth female mold which are disposed on the second movable side metal mold,

wherein, in the first metal mold, a first cavity for molding the first molded product is formed by a first combination of the first female mold and the second male mold, and a second cavity for molding the second molded product is formed by a second combination of the first male mold and the second female mold,

wherein, in the second metal mold, a third cavity for molding the first molded product is formed by a third combination of the third female mold and the fourth male mold, and a fourth cavity for molding the second molded product is formed by a fourth combination of the third male mold and the fourth female mold,

wherein a first space which is in communication with the first cavity and the second cavity is provided between the first cavity and the second cavity, and a second space which is in communication with the third cavity and the fourth cavity is provided between the third cavity and the fourth cavity,

wherein, when the first insertion member is inserted into the first space, the first cavity and the second cavity are isolated, and

wherein, when a second insertion member is inserted into the second space, the third cavity and the fourth cavity are isolated.

According to another aspect of the present invention, there is provided an electronic device including

a composite component,

wherein, in the composite component, a push button and a transparent cover are integrally molded on a first insertion member,

wherein the composite component is molded by a composite component molding metal mold,

wherein the composite component molding metal mold includes

a first metal mold configured to mold a first molded product with a first resin material; and

a second metal mold configured to mold a second molded product with a second resin material,

wherein the first metal mold includes a first movable side metal mold and a first stationary side metal mold, and the second metal mold includes a second movable side metal mold and a second stationary side metal mold,

wherein the first metal mold includes a first male mold and a first female mold which are disposed on the first stationary side metal mold, and the first metal mold includes a second male mold and a second female mold which are disposed on the first movable side metal mold,

wherein the second metal mold includes a third male mold and a third female mold which are disposed on the second stationary side metal mold, and the second metal mold includes a fourth male mold and a fourth female mold which are disposed on the second movable side metal mold,

wherein, in the first metal mold, a first cavity for molding the first molded product is formed by a first combination of the first female mold and the second male mold, and a second cavity for molding the second molded product is formed by a second combination of the first male mold and the second female mold,

wherein, in the second metal mold, a third cavity for molding the first molded product is formed by a third combination of the third female mold and the fourth male mold, and a fourth cavity for molding the second molded product is formed by a fourth combination of the third male mold and the fourth female mold,

wherein a first space which is in communication with the first cavity and the second cavity is provided between the first cavity and the second cavity, and a second space which is in communication with the third cavity and the fourth cavity is provided between the third cavity and the fourth cavity,

wherein, when the first insertion member is inserted into the first space, the first cavity and the second cavity are isolated, and

wherein, when a second insertion member is inserted into the second space, the third cavity and the fourth cavity are isolated.

With the above-described configuration, the first cavity for molding the first molded product and the second cavity for molding the second molded product can be isolated by inserting the first insertion member into the first space which is in communication with the first cavity and the second cavity. Similarly, the third cavity for molding the first molded product and the fourth cavity for molding the second molded product can be isolated by inserting the second insertion member into the second space which is in communication with the third cavity and the fourth cavity. Accordingly, the first molded product which is formed of the first material and the second molded product which is formed of the second material can be independently formed on the first insertion member as a first base. At the some time, the first molded product and the second molded product can be molded so that the first molded product and the second molded product have corresponding functions. Similarly, the first molded product which is formed of the first material and the second molded product which is formed of the second material can be independently formed on the second insertion member as a second base. At the same time, the first molded product and the second molded product can be molded so that the first molded product and the second molded product have corresponding functions.

Other objects, features and advantages of the present invention will become more apparent from the following detailed description when read in conjunction with the accompanying drawings.

### BRIEF DESCRIPTION OF THE DRAWINGS

FIG. 1 is a front sectional view of a composite component molding metal mold according to an example;

FIGS. 2A-2E are diagrams illustrating a schematic manufacturing process in which a molded product is manufactured by the composite component molding metal mold according to the example;

FIGS. 3A and 3B are enlarged views which magnify a portion of a first metal mold;

FIGS. 4A and 4B are enlarged views which magnify a portion of a second metal mold;

FIG. 5 is a perspective view illustrating a composite component according to another example, which is adopted for an inkjet recording head;

FIG. 6 is a cross sectional view of the inkjet recording head in which the composite component according to the other example is adopted;

FIG. 7 is a schematic perspective view showing major portions of an inkjet recording apparatus according to another example;

FIG. 8 is a schematic front cross sectional view partially showing mechanical portions of the inkjet recording apparatus; and

FIG. 9 is a perspective view of a composite component of an electronic device according to another example.

### DETAILED DESCRIPTION OF THE PREFERRED EMBODIMENTS

In a composite component molding metal mold according to related art, a component which is formed of a first resin material is molded, and subsequently a second resin material is integrally formed on the component. With this component molding metal mold, it is difficult to produce a molded component such that a first molded component formed of the first resin material and the second molded component formed of the second resin material are connected on an insertion member, while the first molded component and the second molded component are molded as independent components.

Accordingly, there is a need for a composite component molding metal mold which can form a first molded product formed of a first resin material and a second molded product formed of a second resin material, while the first molded product and the second molded products are independently formed on an insertion member as a base.

Hereinafter, there is explained an embodiment of the present invention by referring to the accompanying drawings. In examples and modified examples, once a component is explained by attaching a reference numeral, subsequently the same reference numeral is attached to components having the same functions, the same shapes, and the like, provided that there is no possibility of confusion, and thereby repeated explanations are omitted. When an explanation is given by referring to a component of another published unexamined patent application or the like, its numerical reference is shown by enclosing it in a parenthesis. In this manner, such a component is distinguished from those of the embodiment.

### Example

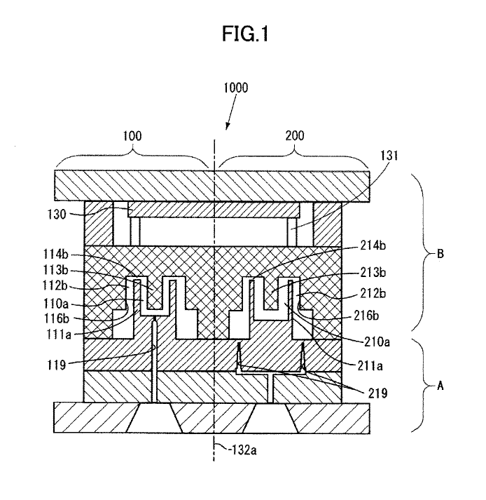

There is explained a composite component molding metal mold 1000 according to an example by referring to FIG. 1. FIG. 1 is a front sectional view of the composite component molding metal mold 1000 according to the example. As shown in FIG. 1, the composite component molding metal mold 1000 includes a first movable side metal mold B and a first stationary side metal mold A. In the composite component molding metal mold 1000, a first metal mold 100 and a second metal mold 200 are integrated across a center line 132a, which indicates a rotation axis. The first metal mold 100 and the second metal mold 200 are symmetrically disposed across the center line 132a. A shape of the first movable side metal mold B of the first metal mold 100 and a shape of a second movable side metal mold 8 of the second metal mold 200 are bilaterally symmetrical (line symmetry) with respect to the center line 132a which indicates the rotational axis.

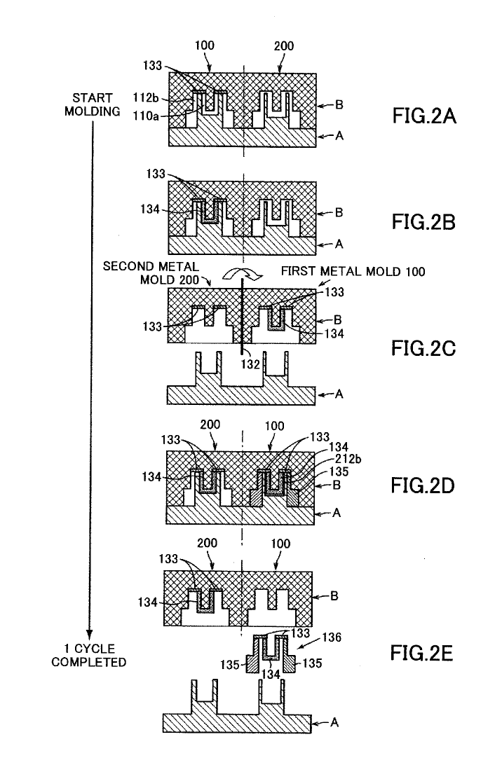

The first metal mold 100 includes a first cavity 110a and a second cavity 112b. The first cavity 110a is formed of a combination of the first stationary side metal mold A and the first movable side metal mold B. The first cavity 110a is for molding a first molded product 134 (cf. FIG. 28). The second cavity 112b is formed of the combination of the first stationary side metal mold A and the first movable side metal mold 8, and the second cavity 112b is for molding a second molded product 135 (cf. FIG. 2D). The cavity 110a is formed of a first female mold 111a, which is disposed in the first stationary side metal mold A, and a second male mold 113b, which is disposed in the first movable side metal mold B. The first female mold 111a forms a concave shape. The second male mold 113b forms a convex shape. The second cavity 112b is formed of a first male mold 111a, which is disposed in the first stationary side metal mold A and a second female mold 116b, which is disposed in the first movable side metal mold B. Here, the first male mold 111a corresponds to an outer wall portion of the first female mold 111a. The second female mold 116b corresponds to an outer wall portion of the second cavity 112b. Between the first cavity 110a and the second cavity 112b, first spaces 114b are provided. The first spaces 114b are in communication with each other. The first cavity 110a and the second cavity 112b are in communication with the first spaces 114b, and thereby the first cavity 110a and the second cavity 112b are connected.

The second metal mold 200 includes a third cavity 210a and a fourth cavity 212b. The third cavity 210a is formed of a combination of a second stationary side metal mold A of the second metal mold 200 and the second movable side metal mold B. The third cavity 210a is for accommodating and protecting the first molded product 134 which is molded by the first metal mold 100. The fourth cavity 212b is formed of the combination of the second stationary side metal mold A and the second movable side metal mold B. The fourth cavity 212b is for molding the second molded product 134. The third cavity 210a is formed of a third female mold 211a, which is disposed in the second stationary side metal mold A, and a fourth male mold 213b, which is disposed in the second movable side metal mold B. The third female mold 211a forms a concave shape. The fourth male mold forms a convex shape. The fourth cavity 212b is formed of a third male mold 211a, which is disposed in the second stationary side metal mold A, and a fourth female mold 216b, which is disposed in the second movable side metal mold B. Here, the third male mold 211a corresponds to an outer wall portion of the third female mold 211a. The fourth female mold 216b corresponds to an outer wall portion forming the fourth cavity 212b. Between the third cavity 210a and the fourth cavity 212b, second spaces 214b are provided. The second spaces 214b are in communication with each other. The third cavity 210a and the fourth cavity 212b are in communication with the second spaces 214b, and thereby the third cavity 210a and the fourth cavity 212b are connected.

The third female mold 211a forms a concave shape. The concave shape is a size larger than that of the first female mold 111a which is disposed in the first stationary side metal mold A of the first metal mold 100. The concave of the third female mold 211a has a shape such that it surrounds and separates the first molded product 134, as described later. The concave of the third female mold 211a does not contact the first molded product 134.

The first and second movable side metal molds B include a push-out plate 130, which is for pushing out a molded product. A push-out pin 131 for pushing out a molded product is disposed on the push-out plate 130 at a side of the second metal mold 200. The reference numeral 119 of FIG. 1 indicates a first gate (a filer port) which is for injecting a first resin material into the first cavity 110a. Here, the first resin material is for molding the first molded product 134. The first gate 119 is disposed in the first stationary side metal mold A of the first metal mold 100. The reference numeral 219 of FIG. 1 indicates a second gate which is for injecting a second resin material into the second cavity 212b. Here, the second resin material is for molding the second molded product 135. The second gate 219 is disposed in the second stationary side metal mold A of the second metal mold 200.

There is explained a process of manufacturing a molded product with the composite component molding metal mold by referring to FIGS. 2A-2E. FIGS. 2A-2E are diagrams illustrating a schematic manufacturing process for manufacturing the molded product with the composite component molding metal mold according to the example. First, as shown in FIG. 2A, insertion members 133 are inserted into the first spaces 114b of the first metal mold 100, and the first and second movable side metal molds B are pressed toward the first and second stationary side metal molds A. Subsequently, as shown in FIG. 2B, the first molded product 134 is molded by injecting the first resin material into the first cavity 110a of the first metal mold 100.

Subsequently, as shown in FIG. 2C, the first and second movable side metal molds B are separated from the first and second stationary side metal molds A. The first movable side metal mold B of the first metal mold 100 and the second movable side metal mold B of the second metal mold 200 are exchanged by rotating the first and second movable side metal molds B around the rotational axis 132 by 180 degrees. At this time, in the first movable side metal mold B of the first metal mold 100, the first molded product 134 which is molded with the first resin material is left in the first movable side metal mold B of the first metal mold 100 in a state in which the first molded product 134 is integrally formed on the insertion members 133, and next insertion members 133 are inserted into the second spaces 214b of the second metal mold 200.

Subsequently, as shown in FIG. 2D, the first resin material is inserted into the first cavity 110a, which is formed by closing the first stationary side metal mold A of the first metal mold 100 and the second movable side metal mold B of the second metal mold 200, while they are facing each other. At the same time, the second resin material is injected into the fourth cavity 212b, which is formed of the second stationary side metal mold A of the second metal mold 200 and the first movable side metal mold B of the first metal mold 100. When the second resin material is injected, the first molded product 134 which is molded with the first resin material is surrounded by the third female mold 211a, which is disposed in the second stationary side metal mold A of the second metal mold 200. The first molded product 134 does not contact the third female mold 211a, and the first molded product 134 is in a state in which the first molded product 134 is separated from and protected by the third female mold 211a.

Subsequently, as shown in FIG. 2E, the first and second movable side metal molds B are separated from the first and second stationary side metal molds A. A composite component 136, in which the insertion members 133, the first molded product 134 and the second molded product 135 are integrated, is pushed out from the first movable side metal mold B of the metal mold 100 by the push-out pin 131, which is disposed in the push-out plate 130 shown in FIG. 1. In this manner, the composite component 136 is taken out from the first movable side metal mold B. By repeating the sequence of operations, the composite components 136 are continuously molded.

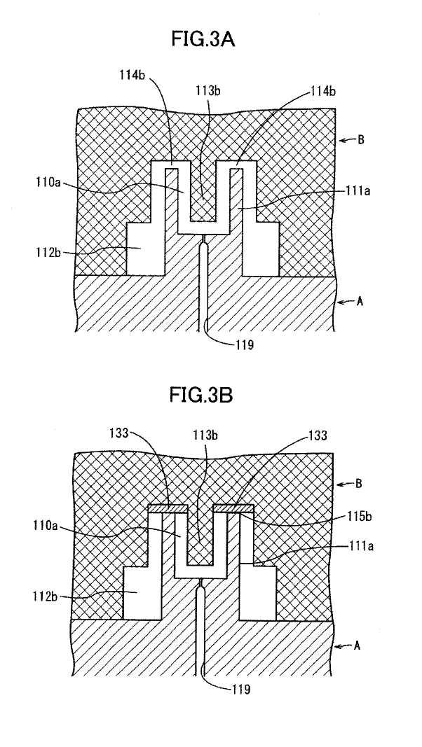

FIGS. 3A and 3B are diagrams in which a portion of the first metal mold 100 is magnified. As shown in FIG. 3A, the first cavity 110a is formed by the first female mold 111a and the second male mold 113b. Here, the first female mold 111a is disposed in the first stationary side metal mold A and molds the outer wall of the first molded product 134. The second male mold 113b is disposed in the first movable side metal mold B and molds an inner wall of the first molded product 134. The second cavity 112b, which molds the second molded product 135, and the first cavity 110a are in communication with the first spaces 1146, which are provided at corresponding top ends in FIG. 3A, thereby the first cavity 110a and the second cavity 1126 are connected. As shown in FIG. 3B, by inserting the insertion members 133 into the corresponding first spaces 114b, the first cavity 110a and the second cavity 112b are partitioned on a parting line (PL) surface 115b.

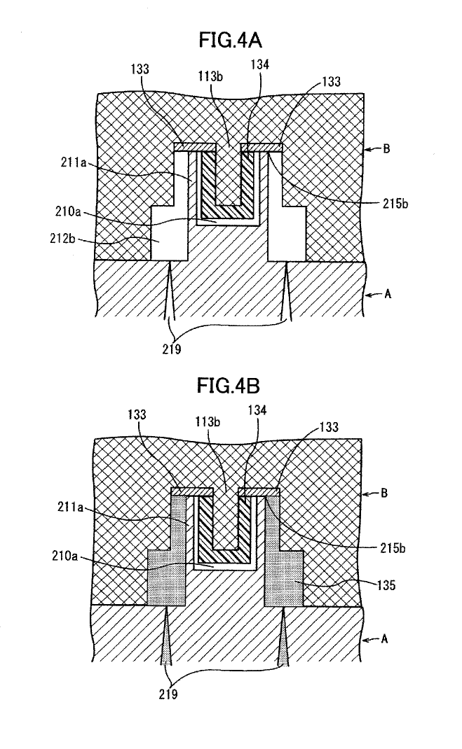

FIGS. 4A and 4B are diagrams in which a portion of the second metal mold 200 is magnified. As shown in FIG. 4A, the third cavity 210a is formed by the third female mold 211a, which is disposed in the second stationary side metal mold A and which molds the inner wall of the second molded product 135, and the fourth male mold 213b, which is disposed in the second movable side metal mold B and which molds the outer wall of the second molded product 135. As shown in FIG. 4B, the second molded product 135 is molded with the second resin material, while the first molded product 134 is protected by the third cavity 210a, which is formed in the second stationary side metal mold A of the second metal mold 200. The first molded product 134 and the second molded product 135 are partitioned by the PL surface 215b. The first molded product 134 and the second molded product 135 are integrally molded on the insertion members 133, while the first molded product 134 and the second molded product 135 are independent. In this manner, the composite component 136 is molded.

According to the example, as described above, by inserting the insertion members 133 into the first spaces 114b between the first cavity 110a for molding the first molded product 134 and the second cavity 112b for molding the second molded product 135, the first cavity 110a can be separated from the second cavity 112b. Here, the first spaces 114b are in communication with each other. In this manner, the first molded product 134, which is formed of the first resin material, and the second molded product 135, which is formed of the second resin material, are independently molded on the insertion members 133 as the base, and the composite component 136 can be obtained. At the same time, the first molded product 134 and the second molded product 135 can be molded to have corresponding functions.

Since the third female mold 211a of the second stationary side metal mold A of the second metal mold 200 which forms the third cavity 210a the concave portion which is a size larger than that of the first female mold 111a of the first stationary side metal mold A of the first metal mold 100, the first molded product 134 can be accommodated in and protected by the concave portion of the third cavity 210a. Further, since the concaved portion has the shape which surrounds and separates the first molded product 134, the first molded product 134 which is formed of the first resin material and the second molded product 135 which is formed of the second resin material can be molded completely independently from each other.

The first molded product 134 and the second molded product 135 are integrally formed on the insertion members 133, and thereby integration of the first molded product 134 and the second molded product 135 on the insertion members 133 is enabled. Further, since the first molded product 134 and the second molded product 135, which are integrally formed on the insert members 133, are independently formed from each other, the first molded product 134 and the second molded product 135 can have corresponding functions which are different from each other, even if the first molded product 134 and the second molded product 135 are integrated.

### Another Example

In examples below, an “image forming apparatus” based on a liquid discharging recording method means an apparatus that performs image formation by adhering liquid droplets onto a medium such as paper, a line, a fiber, fabric, leather, a metal, a plastic, glass, timber, or ceramics, for example. Further, the “image formation” means not only adding an image which has a meaning such as characters or graphics to a medium, but also adding an image which does not have any meaning such as a pattern to a medium (merely adhering liquid droplets onto a medium). The “liquid droplets” are not limited to so-called “ink.” The “liquid droplets” include what is called as recording liquid, a fixation processing solution, a resin, or a solution. The “liquid droplets” is used as a generic term referring to all liquids that can be made to be liquid droplets by granulating, so that an image can be formed. Further, a material of the “recording medium” is not limited to the paper. The material of the recording medium may be a transparency or the cloth. The recording medium means something to which the liquid droplets are adhered. The recording medium is used as a generic term referring to, for example, a medium to be recorded, a recording paper, a paper for recording, a sheet of paper whose thickness is in a range from a thickness of a usable thin paper to a thickness of a usable thick paper, a postcard, an envelope, and a sheet. Further, an image is not limited to a two-dimensional image. The image also includes a three-dimensional image.

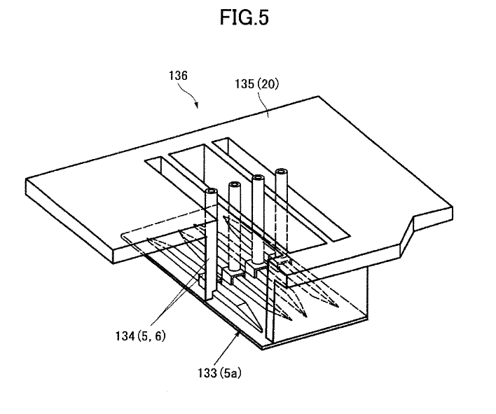

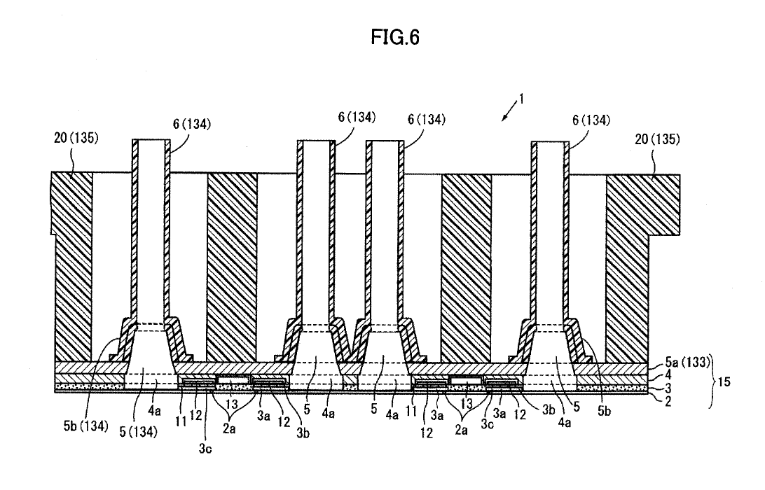

The liquid discharge head according to another example of the present invention is explained by referring to FIGS. 5 and 6. FIG. 5 is a perspective view of a composite component according to the other example. The composite component is adopted as a major portion of an inkjet recording head. The reference numerals shown in the corresponding parentheses indicate that they correspond to the specific names of members/components in FIG. 6. FIG. 6 is a cross-sectional view of the inkjet recording head to which the composite component according to the other example is adopted. The reference numerals shown in the corresponding parentheses indicate that they correspond to the names of members/components in FIG. 5. FIG. 5 shows the liquid discharge head as an example to which the composite component 136 is adopted. Here, the composite component 136 is molded by using the composite component molding metal mold 1000. Specifically, FIG. 5 shows the major portion of the inkjet recording head as an example of the droplet discharge head.

In the example, the first molded product 134 is molded with the first resin material on the insert member 133. Subsequently, the second molded product 135 is molded with the second resin material, and thereby the integrated composite component 136 is molded. Specifically, a common liquid chamber 5 and a communicating tube 6 as a liquid channel are formed on the insertion member 133 as the first molded product 134. Here the common liquid chamber 5 and the communicating tube 6 are formed of a thermoplastic elastomer, which is the first material. Subsequently, a housing 20, which is a chassis, is formed as the second molded product 135. Here, the housing 20 is formed of a polyphenylene sulfide resin (PPS), which is the second material. According to this example, the composite component of the inkjet recording head can be manufactured only by the injection molding process. Here, in the composite component, the common liquid chamber 5 and the communicating tube 6 have a liquid reserving function, a damper function, and a liquid supply circuit function, while the housing 20 has a function of a frame.

An inkjet recording head 1 (which is also referred to as the “recording head 1,” hereinafter) is explained by referring to FIG. 6. The recording head 1 shown in FIG. 6 includes a head main body 15 and a housing 20. The head main body 15 has a configuration to discharge ink droplets in accordance with image information. The housing 20 supports the head main body 15. The housing 20 corresponds to the chassis, which is the second molded product 135 of FIG. 5. The head main body 15 includes a nozzle plate 2; a liquid chamber substrate 3, which is also referred to as an “actuator plate;” an oscillation plate 11; a piezoelectric element 12, a driving circuit member 13; a liquid supply substrate 4; and a common liquid chamber substrate 5a. Here, the nozzle plate 2, the liquid chamber substrate 3, the oscillation plate 11, the piezoelectric element 12, the driving circuit member 13, the liquid supply substrate 4, and the common liquid chamber substrate 5a are laminated in this order from the bottom in an upward direction.

A plurality of nozzle holes 2a is formed in the nozzle plate 2. The nozzle holes 2a are for discharging ink as the liquid droplets. The liquid chamber substrate 3 is disposed on a top surface of the nozzle plate 2. A plurality of pressurized liquid chambers 3a is formed in the liquid chamber substrate 3 as an example of a liquid chamber. The pressurized liquid chambers 3a are in communication with the corresponding nozzle holes 2a. An upper wall of each of the pressurized liquid chambers 3a is formed of the oscillation plate 11. A fluid resistance 3b and an individual liquid chamber 3c are disposed at one side of each of the pressurized liquid chamber 3a. The fluid resistance 3b is in communication with the communication tube 6. The communication tube 6 corresponds to the liquid channel, which is the first molded product 134 of FIG. 5.

The oscillation plate 11 forms a portion of each of the pressurized liquid chambers 3a. The driving circuit member 13 is disposed at center of the oscillation plate 11. The piezoelectric elements 12 which are formed of lead zirconate titanate (PZT) are disposed at both sides of the driving circuit member 13. The piezoelectric element 12 is disposed on the oscillation plate 11 at a position corresponding to each of the pressurized liquid chambers 3a. When a voltage is applied from outside and the piezoelectric element 12 is deformed, the oscillation plate 11 is deformed and pressure is generated in the corresponding pressurized liquid chamber 3a. The piezoelectric element 12 has a function as an electromechanical transducer element which causes the ink in the corresponding pressurized liquid chamber 3a to discharge from the corresponding nozzle hole 2a. An upper electrode (not shown) is formed on the piezoelectric element 12. A lower electrode (not shown) is formed below the piezoelectric element 12. On an electrode pattern (not shown) of the upper electrode and the lower electrode, the driving circuit member 13 is flip-chip bonded.

The liquid supply substrate 4 is disposed on a top surface of the liquid chamber substrate 3. The common liquid chamber substrate 5a forms the common liquid chamber 5. The common liquid chamber substrate 5a is also referred to as a “baking plate.” The common liquid chamber substrate 5a is formed of a thin plate, which is formed of stainless steel (Steel Use Stainless: SUS), and the common liquid chamber substrate 5a corresponds to the insertion member 133 of FIG. 5.

In the common liquid chamber substrate 5a, the common liquid chamber 5 is formed. The common liquid chamber 5 supplies the ink to the corresponding pressurized chamber 3a. The common liquid chamber 5 is in communication with the corresponding pressurized liquid chamber 3a through the communicating tube 6. The common liquid chamber 5 supplies the ink to the corresponding pressurized chamber 3a. The common liquid chamber 5 is in communication with an ink supply port 4a of the liquid supply substrate 4. A common liquid chamber wall 5b forms the common liquid chamber 5. Since the common liquid chamber wall 5b is formed of the thermoplastic elastomer, it has a damper effect. Thus, according to this example, it is possible to remove a damper member which is disposed in a generic recording head.

When a voltage is applied to the upper electrode (not shown) and the lower electrode (not shown) is grounded through the driving circuit member 13, stress is applied to the oscillation plate 11. Here, the upper electrode (not shown) is disposed on an upper portion of the piezoelectric element 12 and the lower electrode (not shown) is disposed on a lower portion of the piezoelectric element 12 (hereinafter, “disposed” means provided and arranged, and provided while the position is determined). With this, a volume of the corresponding pressurized liquid chamber 3a can be varied. Further, the nozzle plate 2 having the nozzle holes 2a is adhered to the bottom of the corresponding pressurized chamber 3a. Subsequently, each of the pressurized chambers 3a is charged with the ink as a liquid. Then, when a voltage is applied to the upper electrode of the piezoelectric element 12 and the lower electrode of the piezoelectric element 12 is grounded, pressure is generated by deformation of the oscillation plate 11, and the ink is discharged from the nozzle hole 2a.

### Another Example

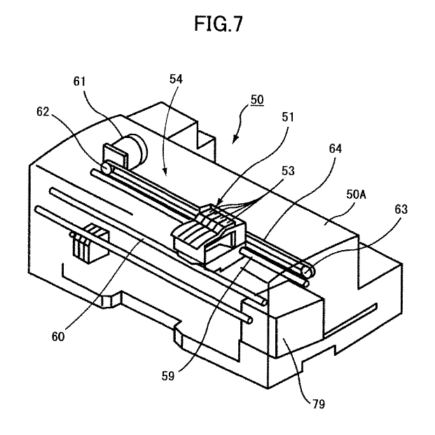

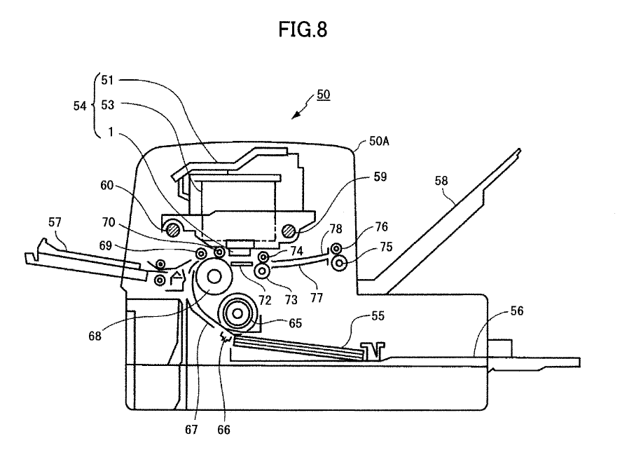

Hereinafter, there is explained an overall configuration of an inkjet recording apparatus 50 as an example of an image forming apparatus according to the embodiment of the present invention by referring to FIGS. 7 and 8. FIG. 7 is a perspective view showing the inkjet recording apparatus 50. FIG. 8 is a schematic front cross sectional view partially showing mechanical portions of the inkjet apparatus 50.

The inkjet recording apparatus 50 according to this example, which is shown in FIGS. 7 and 8, includes the recording head 1, which is shown in FIG. 6. As shown in FIGS. 7 and 8, the inkjet recording apparatus 50 is a serial inkjet recording apparatus. The inkjet recording apparatus 50 includes a carriage 51; the recording head 1; and a printing unit 54. The carriage 51 can be moved in a main scanning direction in a recording apparatus main body 50A. The recording head 1 is mounted on a bottom side of the carriage 51. The printing unit 54 includes an ink cartridge 53. The ink cartridge 54 supplies the ink to the recording head 1.

In a bottom part of the recording apparatus main body 50A, a paper feed cassette 56 is drawably and retractably attached to the recording apparatus main body 50A. Several paper sheets 55 can be fed from a front side (the left side in FIG. 8) of the recording apparatus main body 50A and stacked on the paper feed cassette 56. Above the paper feed cassette 56, a manual feed tray 57 for manually feeding the paper sheets 55 is swingably attached to the recording apparatus main body 50A. The manual feed tray 57 can be opened and closed with respect to the recording apparatus main body 50A. The inkjet recording apparatus 50 takes in the paper sheet 55 which is fed from the paper feed cassette 56 or the manual feed tray 57. After a desired image is recorded on the paper sheet 55 by the printing unit 54, the paper sheet 55 is ejected onto a paper eject tray 58.

In the printing unit 54, the carriage 51 is supported by a main guide rod 59 and a sub guide rod 50, so that the carriage 51 can be slid (which means that the carriage 51 is contacted and slidably moved) in the main scanning direction. The main guide rod 59 and the sub guide rod 50 are horizontally supported by a left side plate (not shown) and a right side plate (not shown). The recording head 1 which discharges yellow (Y) ink droplets, cyan (C) ink droplets, magenta (M) ink droplets, and black (Bk) ink droplets is attached to the carriage 5, while a plurality of ink discharge ports (nozzles) are arranged in a direction which is perpendicular to the main scanning direction. A direction in which the ink droplets are discharged is directed downwardly.

Ink cartridges 53 for supplying the yellow ink, the cyan ink, the magenta ink, and the black ink to the recording head 1, respectively, is replaceably attached to the carriage 51. Each of the ink cartridges 53 includes an air inlet that is in communication with an outside air; a supply port for supplying the corresponding ink to the recording head 1; and a porous body filled with the corresponding ink. Here, the air inlet is arranged at an upper portion of the ink cartridge 53, the supply port is arranged at a lower portion of the ink cartridge 53, and the porous body is disposed inside the ink cartridge 53. The pressure of the ink supplied to the recording head 1 is kept slightly negative by the capillary force of the porous body. Here, as the recording head 1, the recording heads which correspond to yellow, cyan, magenta, and black are utilized. However, a single head including nozzles for discharging corresponding colors of ink may be utilized. A rear side of the carriage 51 (a downstream side in the paper sheet conveyance direction) is slidably supported by the main guide rod 59, and a front side of the carriage 51 (an upstream side in the paper sheet conveyance direction) is slidably placed on the sub guide rod 60. A timing belt 64 is fixed to the carriage 51, so that the carriage 51 can be moved and can scan in the main scanning direction. The timing belt 64 is wound around a drive pulley 62 and a driven pulley 63 (which means that the timing belt 64 is attached to the drive pulley 62 and the driven pulley 63 in a state in which a tension is applied to the timing belt 64, while the timing belt 64 bridges them). The drive pulley 62 is rotationally driven by a main scanning motor 61. The carriage 51 can be reciprocated by the forward and reverse rotations of the main scanning motor 61.

The inkjet recording apparatus 50 includes a paper feeding roller 65 and a friction pad 66 for feeding the paper sheets 55 from the paper feed cassette 56 and for separating the paper sheets 55; a guide member 67 for guiding the paper sheet 55; a conveyance roller 68 that inverts the paper sheet 55 being fed and conveys the paper sheet 55; a pressing roller 69 that is pressed to a peripheral surface of the conveyance roller 68; and a top end roller 70 that defines an angle of sending the paper sheet 55 from the conveyance roller 68, so as to convey the paper sheet 55 being set in the paper feed cassette 56 to a lower side of the recording heads 1.

The conveyance roller 68 is rotationally driven by a sub-scanning motor (not shown) through a sequence of gears. Further, a print support member 72 for guiding the paper sheet 55 sent out from the conveyance roller 68 is disposed at the area below the recording heads 1. The length of the print support member 72 corresponds to a moving range in the main scanning direction of the carriage 51. At the downstream side in the paper sheet conveyance direction of the print support member 72, the inkjet recording apparatus 50 further includes a conveyance roller 73 and a spur 74 that are rotationally driven so as to send the paper sheet 55 in a paper sheet discharging direction; a paper eject roller 75 and a spur 76 for sending the paper sheet 55 onto the paper eject tray 58; and guide members 77 and 78 that form a paper ejection path.

When the inkjet recording apparatus 50 prints an image, the inkjet recording apparatus 50 drives the recording head 1, while moving the carriage 51. In this manner, the recording head 1 discharges the ink onto the paper sheet 55, which remains stationary, and thereby printing corresponding to one line is completed. Subsequently, the inkjet recording apparatus 50 prints the next line, after sending the paper sheet 55 by a predetermined distance. When the inkjet recording apparatus 50 receives a print termination signal or a signal indicating that the end of the paper sheet 55 reaches the printing area, the inkjet recording apparatus 50 terminates the printing operation and ejects the paper sheet 50. Further, the inkjet recording apparatus 50 includes a recovering device 79 for recovering a discharge failure of the recording head 1. The recovering device 79 is disposed at a position outside the printing area. Here, the position is at a rightmost side in a direction in which the carriage 51 moves. The recovering device 79 includes a cap unit, a suction unit, and a cleaning unit. During the print waiting state, the carriage 51 is moved to the side of the recovering device 79, and the recording head 1 is capped by the cap unit. In this manner, the wet conditions of the discharging ports are maintained, and a discharge failure caused by ink drying is prevented. Additionally, during recording, the inkjet recording apparatus 50 causes the recording head 1 to discharge ink that is not related to the recording. In this manner ink viscosity at all the discharge ports are kept constant, and a stable discharging performance is maintained.

When a discharge failure occurs, the inkjet recording apparatus 50 causes the cap unit to seal the discharge ports (nozzles) of the recording head 1. Then, the suction unit suctions bubbles along with the ink from the discharge ports through a tube. The cleaning unit removes the ink or dusts attached to a surface of the discharge ports. In this manner, the discharge failure is recovered. The suctioned ink is discharged to a waste ink reservoir (not shown) disposed at a lower portion of the recording apparatus main body 50A, and an ink absorber in the waste ink reservoir absorbs and reserves the suctioned ink.

As described above, according to this example, the inkjet recording apparatus 50 having the recording head 1, which is not expensive, can be achieved. The recording head 1 demonstrates the above-described effect.

### Another Example

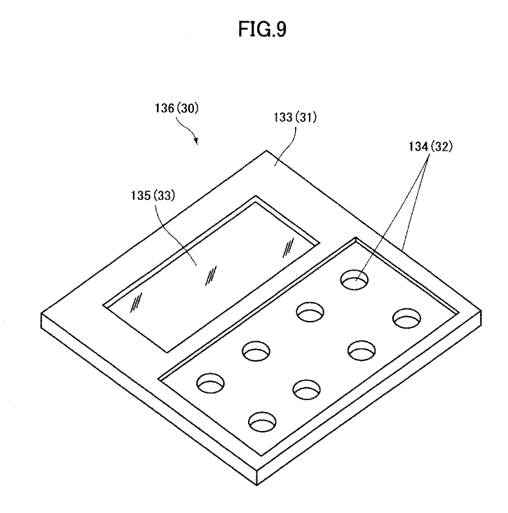

There is explained the composite component 136 of an electronic device 30 according to another example of the embodiment of the present invention by referring to FIG. 9. FIG. 9 is a perspective view of major portions of the composite component 136, which is molded by using the composite component molding metal mold 1000. In this example, the first molded product 134 is molded with the first resin material on the insertion member 133, and subsequently the second molded product 135 is molded with the second resin material, and thereby the composite component 136 of the electronic device 30 is molded, which integrates the first molded product 134, the insertion member 133, and the second molded product 135. Specifically, a plurality of push buttons 32 (which is indicated in the parenthesis) as the first molded product 134 is molded with the thermoplastic elastomer as the first material on a cover 31 (which is indicated in the parenthesis) as the insertion member 133. Subsequently, a transparent cover 33 (which is indicated in the parenthesis) as the second molded product 135 is molded with a clear resin material (e.g., acrylic, or a polycarbonate resin) as the second material on the cover 31.

According to this example, the composite component 136 of the electronic device 30 can be produced only by the injection molding process. Here, the composite component 136 has a function as the cover 31, a function as the transparent cover 33 which includes a windshield function, and a function as the push buttons 32.

Hereinabove, the composite component molding metal mold, the droplet discharge head, the composite component of the electronic device, and the image forming apparatus are explained by the specific embodiment. However, the present invention is not limited to the above-described examples of the embodiment. The examples of the embodiment may be suitably combined, and various modifications and improvements may be made, depending on the necessity and the purpose, within the scope of the present invention.

The scope of the present invention is not limited to the inkjet recording head that discharges infinitesimal ink droplets. For example, the inkjet recording head may be a droplet discharge head that discharges, instead of the ink droplets, infinitesimal droplets of an arbitrary liquid which is used depending on the purpose. Further, the present invention may be applied to a patterning apparatus which employs the droplet discharge head.

The image forming apparatus according to the embodiment of the present invention is not limited to the inkjet recording apparatus 50 which is shown in FIGS. 7 and 8. The image forming apparatus according to the embodiment of the present invention may be applied to an image forming apparatus which includes an inkjet image forming device including the recording head 1 according to the embodiment of the invention. Namely, the image forming apparatus according to the embodiment of the present invention may be applied to a printing apparatus which includes the inkjet image forming device, such as a printer, a plotter, a word processor, a facsimile machine, a copier, or a screen printing machine, or the image forming apparatus according to the embodiment of the present invention may be applied to a compound machine which includes the inkjet image forming device and which has two or more of the above-described functions.

The present invention is not limited to the specifically disclosed embodiments, and variations and modifications may be made without departing from the scope of the present invention.

The present application is based on and claims the benefit of priority of Japanese Priority Application No. 2012-198947, filed on Sep. 10, 2012, the entire contents of which are hereby incorporated herein by reference.

What is claimed is:

1. A composite component molding metal mold configured to mold a composite component, the composite component molding metal mold comprising:
a first metal mold configured to mold a first molded product with a first resin material; and
a second metal mold configured to mold a second molded product with a second resin material,
wherein the first metal mold includes a first movable side metal mold and a first stationary side metal mold, and the second metal mold includes a second movable side metal mold and a second stationary side metal mold,
wherein the first metal mold includes a first male mold and a first female mold which are disposed on the first stationary side metal mold, and the first metal mold includes a second male mold and a second female mold which are disposed on the first movable side metal mold,
wherein the second metal mold includes a third male mold and a third female mold which are disposed on the second stationary side metal mold, and the second metal mold includes a fourth male mold and a fourth female mold which are disposed on the second movable side metal mold,
wherein, in the first metal mold, a first cavity for molding the first molded product is formed by a first combination of the first female mold and the second male mold, and a second cavity for molding the second molded product is formed by a second combination of the first male mold and the second female mold,
wherein, in the second metal mold, a third cavity for molding the first molded product is formed by a third combination of the third female mold and the fourth male mold, and a fourth cavity for molding the second molded product is formed by a fourth combination of the third male mold and the fourth female mold,
wherein a first space which is in communication with the first cavity and the second cavity is provided between the first cavity and the second cavity, and a second space which is in communication with the third cavity and the fourth cavity is provided between the third cavity and the fourth cavity,
wherein, when a first insertion member is inserted into the first space, the first cavity and the second cavity are isolated, and
wherein, when a second insertion member is inserted into the second space, the third cavity and the fourth cavity are isolated.

2. The composite component molding metal mold according to claim 1,
wherein, in the composite component molding metal mold, when the first movable side metal mold of the first metal mold and the second movable side metal mold of the second metal mold turn 180 degrees around a rotational axis, the first movable side metal mold and the second movable side metal mold are exchanged with respect to the first stationary side metal mold and the second stationary side metal mold, and wherein the first movable side metal mold and the second movable side metal mold are in line symmetry with respect to a center line of the rotation axis, and
wherein a second concave portion of the third female mold is a size larger than a first concave portion of the first female mold.

3. The composite component molding metal mold according to claim 2,
wherein the second concave portion has a shape that covers and isolates the first molded product.

4. The composite component molding metal mold according to claim 1,
wherein the first molded product and the second molded product are integrally molded on the first insertion member.

5. The composite component molding metal mold according to claim 4,
wherein the first molded product and the second molded product being integrally molded on the first insertion member are independently molded from each other.

6. A droplet discharge head comprising:
a composite component,
wherein, in the composite component, a common liquid chamber, a liquid channel, and a chassis are integrally formed on a first insertion member,
wherein the composite component is molded by a composite component molding metal mold,
wherein the composite component molding metal mold includes
a first metal mold configured to mold a first molded product with a first resin material; and
a second metal mold configured to mold a second molded product with a second resin material,
wherein the first metal mold includes a first movable side metal mold and a first stationary side metal mold, and the second metal mold includes a second movable side metal mold and a second stationary side metal mold,
wherein the first metal mold includes a first male mold and a first female mold which are disposed on the first stationary side metal mold, and the first metal mold includes a second male mold and a second female mold which are disposed on the first movable side metal mold,
wherein the second metal mold includes a third male mold and a third female mold which are disposed on the second stationary side metal mold, and the second metal mold includes a fourth male mold and a fourth female mold which are disposed on the second movable side metal mold,
wherein, in the first metal mold, a first cavity for molding the first molded product is formed by a first combination of the first female mold and the second male mold, and a second cavity for molding the second molded product is formed by a second combination of the first male mold and the second female mold,
wherein, in the second metal mold, a third cavity for molding the first molded product is formed by a third combination of the third female mold and the fourth male mold, and a fourth cavity for molding the second molded product is formed by a fourth combination of the third male mold and the fourth female mold,
wherein a first space which is in communication with the first cavity and the second cavity is provided between the first cavity and the second cavity, and a second space which is in communication with the third cavity and the fourth cavity is provided between the third cavity and the fourth cavity,
wherein, when the first insertion member is inserted into the first space, the first cavity and the second cavity are isolated, and
wherein, when a second insertion member is inserted into the second space, the third cavity and the fourth cavity are isolated.

7. An image forming apparatus comprising:
a droplet discharge head,
wherein the droplet discharge head includes a composite component,
wherein, in the composite component, a common liquid chamber, a liquid channel, and a chassis are integrally formed on a first insertion member,
wherein the composite component is molded by a composite component molding metal mold,
wherein the composite component molding metal mold includes
a first metal mold configured to mold a first molded product with a first resin material; and
a second metal mold configured to mold a second molded product with a second resin material,
wherein the first metal mold includes a first movable side metal mold and a first stationary side metal mold, and the second metal mold includes a second movable side metal mold and a second stationary side metal mold,
wherein the first metal mold includes a first male mold and a first female mold which are disposed on the first stationary side metal mold, and the first metal mold includes a second male mold and a second female mold which are disposed on the first movable side metal mold,
wherein the second metal mold includes a third male mold and a third female mold which are disposed on the second stationary side metal mold, and the second metal mold includes a fourth male mold and a fourth female mold which are disposed on the second movable side metal mold,
wherein, in the first metal mold, a first cavity for molding the first molded product is formed by a first combination of the first female mold and the second male mold, and a second cavity for molding the second molded product is formed by a second combination of the first male mold and the second female mold,
wherein, in the second metal mold, a third cavity for molding the first molded product is formed by a third combination of the third female mold and the fourth male mold, and a fourth cavity for molding the second molded product is formed by a fourth combination of the third male mold and the fourth female mold,
wherein a first space which is in communication with the first cavity and the second cavity is provided between the first cavity and the second cavity, and a second space which is in communication with the third cavity and the fourth cavity is provided between the third cavity and the fourth cavity,
wherein, when the first insertion member is inserted into the first space, the first cavity and the second cavity are isolated, and
wherein, when a second insertion member is inserted into the second space, the third cavity and the fourth cavity are isolated.

8. An electronic device comprising:
a composite component,
wherein, in the composite component, a push button and a transparent cover are integrally molded on a first insertion member,
wherein the composite component is molded by a composite component molding metal mold,
wherein the composite component molding metal mold includes
a first metal mold configured to mold a first molded product with a first resin material; and
a second metal mold configured to mold a second molded product with a second resin material,
wherein the first metal mold includes a first movable side metal mold and a first stationary side metal mold, and the second metal mold includes a second movable side metal mold and a second stationary side metal mold,
wherein the first metal mold includes a first male mold and a first female mold which are disposed on the first stationary side metal mold, and the first metal mold includes a second male mold and a second female mold which are disposed on the first movable side metal mold,
wherein the second metal mold includes a third male mold and a third female mold which are disposed on the second stationary side metal mold, and the second metal mold includes a fourth male mold and a fourth female mold which are disposed on the second movable side metal mold,
wherein, in the first metal mold, a first cavity for molding the first molded product is formed by a first combination of the first female mold and the second male mold, and a second cavity for molding the second molded product is formed by a second combination of the first male mold and the second female mold,
wherein, in the second metal mold, a third cavity for molding the first molded product is formed by a third combination of the third female mold and the fourth male mold, and a fourth cavity for molding the second molded product is formed by a fourth combination of the third male mold and the fourth female mold,
wherein a first space which is in communication with the first cavity and the second cavity is provided between the first cavity and the second cavity, and a second space which is in communication with the third cavity and the fourth cavity is provided between the third cavity and the fourth cavity,
wherein, when the first insertion member is inserted into the first space, the first cavity and the second cavity are isolated, and
wherein, when a second insertion member is inserted into the second space, the third cavity and the fourth cavity are isolated.
